(19) United States
(12) Patent Application Publication
(10) Pub. No.: US 2011/0093780 A1
(43) Pub. Date: Apr. 21, 2011

(54) ADVERTISING AVATAR

(75) Inventors: MELISSA W. DUNN, WOODINVILLE, WA (US); ABIGAIL AMY COLANDO, Seattle, WA (US)

(73) Assignee: MICROSOFT CORPORATION, REDMOND, WA (US)

(21) Appl. No.: 12/580,948

(22) Filed: Oct. 16, 2009

(51) Int. Cl. G06F 3/048

(52) U.S. Cl. 715/706

(57) ABSTRACT

An advertising avatar provides an engaging advertising experience. To create an advertising avatar, a user provides information that may be used to target advertisements to the user. The information is stored in a user profile and associated with an avatar ID. Additionally, an avatar image is created for the advertising avatar that is based on information provided by the user. The more information the user provides, the more fully featured the appearance of the avatar image becomes. When an advertisement is to be displayed on a user's client device, an advertisement is selected based on information in the user profile. The avatar image for the user's advertising avatar may be presented within the advertisement when the advertisement is presented on the user's client device. The presence of the avatar image within an advertisement may provide an indication to the user that the advertisement supports user interaction.

### BACKGROUND

Advertising is an established way for merchants to reach an audience of potential customers. Ideally, merchants desire to have their advertisements directed to individuals that are likely to purchase the merchants' products and services. Accordingly, advertising has gone through an evolution of targeting approaches. Initially, advertising was often generally untargeted. However, over time, merchants began to target potential customers in a number of ways. For instance, merchants often target a particular audience by selectively choosing the medium (e.g., newspapers, magazines, radio, television, etc.) in which to advertise. Additionally, advertising is often targeted by selecting the particular context (e.g., specific shows on television, specific web pages on the Internet, etc.) within which the advertisements will appear.

Online advertising has become a significant aspect of computing environments, as it presents a powerful way for advertisers to market their products and services. For instance, online advertising is often more likely to allow advertisers to effectively deliver advertisements to their target audiences as compared with traditional media advertising, such as newspapers, magazines, and radio. Additionally, there are a variety of advertising systems and methods for delivering online advertisements for presentation to users. Generally, online advertising includes any form of advertising that uses computer network environments to deliver advertisements and other marketing messages to potential customers. For instance, advertisements may be presented within web pages, search engine search results, online video games, advertisement-based software applications, and email messages, to name a few. A wide variety of additional approaches and environments exist for delivering online advertising for presentation to users. Despite the advantages that existing online advertising has presented, improvements may still be made, such as, for instance, in targeting advertisements to users and providing users with an engaging advertising experience that is likely to result in conversions for advertisers.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to using an avatar for advertising purposes. A user creates an advertising avatar by providing information to an advertising system and/or allowing the advertising system to track behavioral information for the user. The information is stored in a user profile and associated with an avatar ID. Additionally, an avatar image is created based at least in part on the information provided by and/or tracked for the user. As such, the more information the user provides and/or allows to be tracked, the more full featured the avatar image becomes. An avatar widget is stored on the user's client device that includes code for interacting with an advertising system and acts as a container for the avatar ID on the user's client device. When an advertisement is to be presented on the user's client device, an advertisement request, which may include the avatar ID, is sent to an advertising system. Based on the avatar ID, a user profile is identified and an advertisement is selected based on data in the user profile. The selected advertisement is provided to the client device. In some embodiments, an avatar image is presented within the advertisement when the advertisement is presented on the client device. The presence of the avatar image in the advertisement may be used to provide an indication that the advertisement supports user interaction.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a flow diagram showing a method for creating an advertising avatar for a user in accordance with an embodiment of the present invention;

FIG. 4 is a flow diagram showing a method performed by a client upon initiation of an ad control in accordance with an embodiment of the present invention;

FIG. 5 is a flow diagram showing a method performed by an ad platform for selecting an advertisement in response to an advertisement request from a client device in accordance with an embodiment of the present invention;

FIG. 6 is a flow diagram showing a method for presenting an advertisement in an application on a client device in accordance with an embodiment of the present invention;

FIG. 7 is an illustrative screen display showing an avatar widget/icon in accordance with an embodiment of the present invention;

FIG. 8 is an illustrative screen display showing an avatar image as part of a progress bar in accordance with an embodiment of the present invention; and

FIG. 9 is an illustrative screen display showing display of an advertising avatar image within an advertisement in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to an advertising avatar that facilitates providing users with an engaging and entertaining advertising experience. Users create an advertising avatar by providing information, such as, for instance, demographic information, personality traits, likes, and dislikes, to an advertising system and/or allowing the advertising system to track behavioral information. The advertising system creates/edits a user profile based on the information and associates an avatar ID with the user profile. Additionally, the advertising system creates/edits an avatar image and associates the avatar image with the user profile and avatar ID. In various embodiments of the present invention, portions of the avatar image may be explicitly controlled by the user, such as, for instance, skin color and hair color, while other portions of the avatar image, such as, for instance, accessories and actions, may be automatically selected by the advertising system based on the information provided by and/or tracked for the user and stored in the user profile. As such, the more information the user shares with the advertising system (either directly or indirectly via behavioral tracking), the more fully featured the avatar image becomes in features and/or actions. The avatar thus becomes an incentive for the user to provide more detailed information to the advertising system that may be used by the advertising system to better target advertisements to the user.

An advertising avatar widget may be installed on one or more client devices owned and operated by the user. The advertising avatar widget provides code facilitating interaction between a client device and an advertising system. Additionally, the advertising avatar widget may act as a container for storing the user's avatar ID on the client device. When an application on the client device requires an advertisement, a request for an advertisement may be communicated from the client device to the advertising system. The request may include the avatar ID. Using the avatar ID, the advertising system accesses the corresponding user profile and selects an advertisement based on the information contained in the user profile. Additionally, in some embodiments, an advertisement may be identified as one in which an avatar image is to be presented such that the avatar image appears as part of the advertisement experience. In such embodiments, the advertisement is communicated to the client device and presented thereon with the avatar image corresponding with the avatar ID.

Accordingly, in one aspect, an embodiment of the present invention is directed to one or more computer-readable media storing computer-useable instructions that, when used by one or more computing devices, causes the one or more computing devices to perform a method. The method includes receiving personal information from a user, the personal information describing at least one of the following: demographic information for the user, a personality trait of the user, a like of the user, and a dislike of the user. The method also includes storing the personal information in a user profile and associating the user profile with an avatar ID. The method further includes employing at least a portion of the personal information from the user profile to determine at least a portion of an appearance of an avatar image for the user. The method still further includes employing at least a portion of the personal information from the user profile to select online advertisements for electronic delivery to the user.

In another embodiment, an aspect of the invention is directed to a method performed by one or more server devices for selecting and providing an advertisement to a client device. The method includes receiving, from a client device, a request for an advertisement for presentation within an application on the client device. The method also includes identifying an avatar ID based on the request for the advertisement. The method further includes accessing a user profile associated with the avatar ID, the user profile comprising personal information for a user associated with the avatar ID. The method also includes selecting an advertisement based at least in part on at least a portion of the personal information from the user profile. The method further includes determining that an avatar image is to be presented within the advertisement. The method still further includes providing the advertisement to the client device, and providing, to the client device, an avatar image or an indication that an avatar image is to be presented within the advertisement, wherein the avatar image is presented within the advertisement on the client device.

A further embodiment of the present invention is directed to one or more computer-readable media storing computer-useable instructions that, when used by one or more computing devices, causes the one or more computing devices to perform a method. The method includes receiving personal information from a user, the personal information describing at least one of the following: demographic information for the user, a personality trait of the user, a like of the user, and a dislike of the user. The method further includes creating an advertising avatar for the user based on at least a portion of the personal information from the user. The advertising avatar is associated with an avatar ID comprising an anonymous identifier. The advertising avatar is also associated with an avatar image, wherein at least a portion of the avatar image is explicitly specified by the user, and wherein the avatar image includes an accessory automatically determined based on at least a portion of the personal information from the user without the user explicitly specifying the accessory. The method also includes communicating an avatar widget to a user device for storage on the user device. The avatar widget comprises code for causing the user device to interact with a remote advertisement platform to facilitate delivery of advertisements to the user device for presentation to the user. The avatar widget also acts as a container for storing the avatar ID on the user device. The method further includes receiving, from the user device, a request for an advertisement, wherein the request includes the avatar ID. The method also includes selecting an advertisement based at least in part on at least a portion of the personal information received from the user. The method further includes determining that the advertisement is configured to allow user interaction with the advertisement, and based on the determination that the advertisement is configured to allow user interaction with the advertisement, retrieving the avatar image. The method still further includes providing the advertisement and the avatar image to the user device, wherein the avatar image is presented within the advertisement on the user device to indicate to the user that the advertisement allows user interaction.

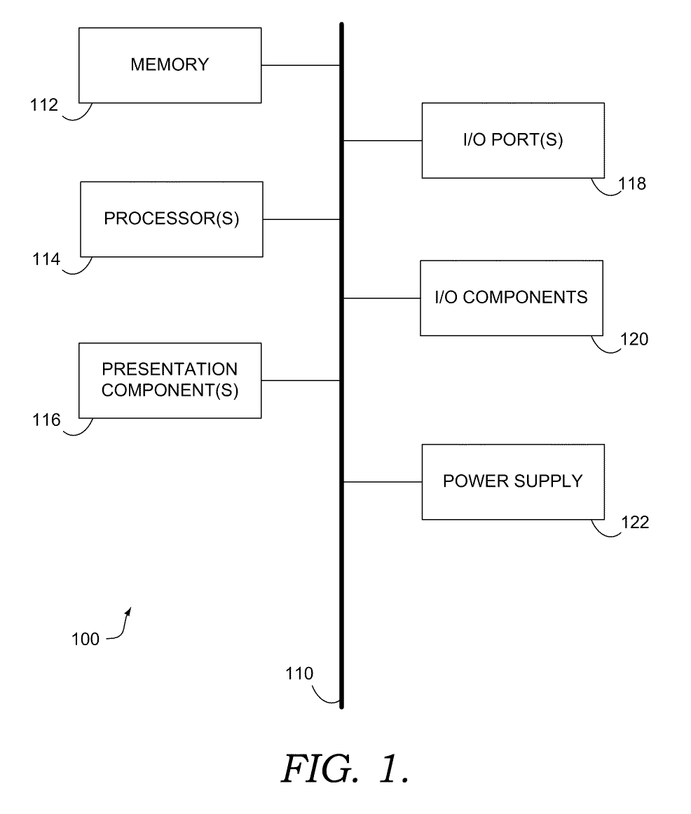

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As indicated previously, embodiments of the present invention are directed to providing users with the ability to create their own advertising avatars and employing the advertising avatars for advertising purposes. As will be described in further detail below, a user may create and edit an advertising avatar by providing information regarding the user to the advertising system and/or allowing the advertising system to track behavioral information for the user. This information is stored by the advertising system in a user profile for the user in association with an avatar ID and is employed by the advertising system to determine at least a portion of the avatar image for the user's advertising avatar. Accordingly, the more information the user provides to the advertising system and/or the more information the user allows the advertising system to track, the more fully featured the user's avatar image becomes in appearance and/or actions. The information in the user's profile is also used by the advertising system to select advertisements for delivery and presentation to the user.

In accordance with embodiments of the present invention, a client framework is installed on client device(s) owned and operated by a user. The client framework includes an advertising avatar widget that includes code facilitating advertising functionality described herein. The advertising avatar widget acts as a container for an avatar ID on the client device. Whenever a user logs in, the avatar ID is embedded in the avatar widget. Using the avatar widget as a container for the avatar ID provides advantages as the avatar ID may be used across media, products, and services.

As will be described in further detail below, the avatar ID may be employed for a variety of purposes. Generally, the avatar ID is employed by the advertising system to select advertisements for delivery to the user. In some embodiments, the avatar ID may be used by the advertising system to identify an avatar image for placement within an advertisement. Additionally, the avatar ID may be employed by the advertising system to track behavioral information. Further, the avatar ID may be employed by applications and services for sign-on purposes. In some embodiments of the present invention, the avatar ID is an anonymous identifier (ANID) such that no personally identifiable information (e.g., the user's name, address, etc.) is associated with the avatar ID. In such embodiments, the use of an ANID for the avatar ID allows the advertising system to provide an anonymous experience for the user as the user may not be identified using any information received by the advertising system and stored in association with the avatar ID.

A user's advertising avatar may be shared across the user's client devices. In particular, the client framework including the advertising avatar widget may be installed on each of the user's client devices and the user's avatar ID may be embedded in the avatar widget on each device. Additionally, the user's avatar may be synched across the user's devices using, for instance, the LIVE MESH synchronization service provided by Microsoft Corporation or similar synchronization services.

As indicated previously, a user initially creates an advertising avatar. The user can create a new avatar, use a base avatar provided by the system, or use an existing avatar for the user originating from another computing environment. As an example of the latter, the user may have already created an avatar in a gaming system, such as the XBOX gaming system provided by Microsoft Corporation. The user may choose to use the previously created avatar as his/her advertising avatar.

An avatar image is created for the user's advertising avatar. In some embodiments of the present invention, the user may explicitly specify certain visual attributes of the avatar image. By way of example only and not limitation, the user may specify the avatar's skin color and hair color. In instances in which the user selects to employ an existing avatar from another computing environment, the avatar image for the user's advertising avatar may be based on the avatar image for the existing avatar. In addition to allowing the user to explicitly specify some aspects of the avatar image for the user's advertising avatar, the system automatically selects additional aspects of the avatar image based on information the user explicitly provides to the advertising system and/or allows the advertising to track via behavioral tracking and that may be used by the advertising system to target advertisements to the user. In some embodiments, these additional aspects of the avatar image include accessories and/or actions performed by the avatar that are automatically selected by the advertising system and may be added to the avatar image only if the user provides information and/or allows the advertising system to track information. In other words, the user cannot explicitly specify the aspects of the avatar image but the aspects can only be obtained if the advertising system receives information that may be used for advertising targeting purposes. As such, the advertising avatar incentivizes the user to provide such information and/or allow the advertising system track such information. As a further incentive, in some embodiments, if the user interacts with advertisements provided by the advertising system, the user may be given credits that may be used to obtain further features for the avatar image.

As indicated above, when creating an advertising avatar, the user is given the opportunity to provide information that is stored in a profile associated with the avatar. The user may also edit the profile information associated with an avatar at any time. In accordance with various embodiments of the present invention, the user may specify information such as demographic information, personality traits, likes, and dislikes. This information may be used by the advertising system to target advertisements to the particular user. As noted above, as an incentive for the user to provide information to the advertising system, the more information the user provides to the system, the more fully featured the avatar image becomes in appearance and actions.

In one embodiment, the advertising system provides a personality test that allows the user to place himself/herself into one or more named segments corresponding with a personality trait of the user. As part of the personality test, the user may select from a number of statements that match the user's personality. Based on the user selections, one or more personality traits are associated with the user's avatar. By way of example only and not limitation, the named segments or personality traits may include “rolling stone,” “sports nut,” “gadget geek,” “fashionista,” “super parent,” “speed racer,” and “committed.”

As an inducement for the user to provide information as part of the personality test, each personality trait may include at least one item that appears as part of the avatar image. Accordingly, if the user completes the personality test resulting in a number of personality traits being associated with the user's advertising avatar, the avatar image will include items that correspond with the identified personality traits. The item may be an accessory for the avatar and/or an action that the avatar may perform. The following provide a number of examples of items that may be provided as part of an avatar image for different personality traits: an airline boarding pass for a “rolling stone,” a baseball cap for a “sports nut,” a cool gadget such as a phone for a “gadget geek,” sunglasses for a “fashionista,” kid figures for a “super parent,” a cool car for a “speed racer,” and a wedding ring for “committed.”

As an additional incentive for users to provide information as part of the personality test, the advertising system may create communities based on personality traits where membership to the communities is gated by having the corresponding personality trait. In other words, the user may access a community only if the user has completed the personality test and been identified as having a personality trait corresponding with the community.

Information provided by the user via the personality test is used by the advertising system to appropriately target advertisements to the user. In particular, advertisements that correspond with the user's personality traits will be delivered to the user while advertisements that do not correspond with the user's personality will not. As an example of the former, if the user is identified as a “rolling stone,” advertisements associated with travel may be delivered to the user. As example of the latter, if the user is identified as “committed,” the advertising system will not serve advertisements related to dating services.

In some embodiments of the present invention, the user may additionally or alternatively provide information regarding the user's likes and/or dislikes. As with the information provided by the user as part of the personality test, information provided by the user regarding the user's likes and/or dislikes will contribute to the user's advertising experience. In particular, information provided by the user regarding the user's likes and/or dislikes will affect the advertisements that are selected for delivery to the user. For instance, advertisements corresponding with the user's likes will be selected for delivery while advertisements associated with the user's dislikes will not. Additionally, information regarding the user's likes and/or dislikes may be used by the advertising system to provide accessories and/or actions for the avatar image.

A taxonomy may be provided to allow the user to specify the user's likes and/or dislikes by making selections from the taxonomy. In some embodiments, the taxonomy provides a hierarchy of items that allows the user to select items of varying specificity. For instance, the user may indicate “food” as a general like. Alternatively, the user may drill down further in the taxonomy to provide more specificity, such as, for instance, identifying “Chinese restaurants” as a like. As another alternative, the user may drill down even further in the taxonomy to provide an identification of a particular merchant (e.g., a particular restaurant) as a like.

In embodiments, the taxonomy is a predetermined hierarchy developed for the advertising system. The user may simply navigate through the taxonomy to indicate likes and/or dislikes. In some embodiments, the taxonomy employed by users to identify their likes and/or dislikes is the same taxonomy used by application developers and site publishers to describe their context and by advertisers to describe their target audiences. Allowing users to identify likes and/or dislikes using the same taxonomy as that employed by advertisers provides direct correspondence between what users indicate as likes/dislikes and what advertisers identify as being useful in advertisement selection. As such, advertisements selected for each user may be particularly targeted for the user.

In some embodiments, users can add new elements to the taxonomy. New elements may be added by users to any hierarchical level within the taxonomy. For instance, the user may provide new high level elements corresponding with general specificity (e.g., “clothes”). The user may also provide new low-level elements corresponding to particular specificity (e.g., specifying a particular merchant). Elements added to the taxonomy can then be used by other users, advertisers, application developers, and/or site publishers. Additionally, elements added to the taxonomy may be used by the advertising system provider to attract advertisers. For instance, a user may add a particular merchant to the taxonomy and other users may identify the merchant as a like. The advertising system provider may provide such information to the merchant in an attempt to attract the merchant as an advertiser with the advertising system.

In addition to providing an engaging and entertaining advertising experience based on information users explicitly provide, the advertising system may collect information for users using behavioral tracking. In accordance with some embodiments of the present invention, behavioral tracking may include collecting URLs of webpages the user has visited, search query requests submitted by the user, user interaction with advertisements, and application contexts, to name a few. The information collected via behavioral tracking may be added to the user's profile and used to determine aspects of the user's avatar image and/or select advertisements for delivery to the user. In embodiments, the user is provided the option to either opt in or opt out of behavioral tracking. Additionally, the user may opt in or opt out of particular information that will be tracked. For instance, the user may decide to allow the advertising system to track search requests submitted by the user but not allow the advertising system to track webpages visited by the user. Further, the user can globally opt out of behavioral tracking or may opt out of behavioral tracking on a per session basis.

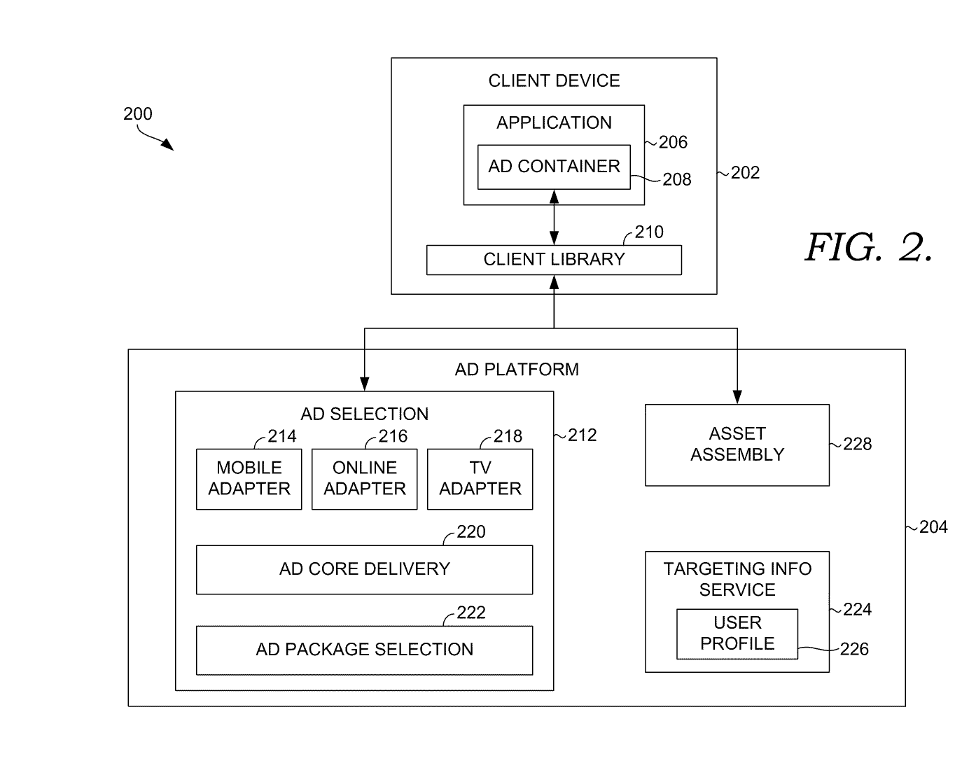

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 generally includes a client device 202 and an ad platform 204. The client device 202 and ad platform 204 may each include any type of computing device, such as computing device 100 described with reference to FIG. 1, for example. The components of the system 200 may communicate with each other via a network, which may include, without limitation, one or more local area networks (LANs) and/or wide area networks (WANs). Such networking environments are commonplace in offices, enterprise-wide computer networks, intranets, and the Internet. It should be understood that any number of client devices and ad platforms may be employed within the system 200 within the scope of the present invention. Each may comprise a single device or multiple devices cooperating in a distributed environment. For instance, the ad platform 204 may comprise multiple devices arranged in a distributed environment that collectively provide the functionality of the ad platform described herein. Additionally, other components not shown may also be included within the system 200.

Generally, the system 200 illustrates an environment in which the client device 202 requests and receives advertisements from the ad platform 204 by employing a user's advertising avatar. The client device 202 may be any of a number of different types of devices owned and operated by a user, such as, for instance, a desktop computer, a laptop computer, or a mobile device, such as a phone or media player. The client device 202 includes an application 206 that provides an environment for displaying an advertisement. The application 206 may comprise any type of application in which an advertisement may be presented. By way of example only and not limitation, the application may be a gaming application or web browsing application. As shown in FIG. 2, the application 206 includes an advertisement container 208. The advertisement container 208 represents a location within the application 206 at which an advertisement may be displayed to the user.

When an advertisement is to be presented within the application 206, a request for an advertisement is made to a client library 210 on the client device 202. In some instances, one or more advertisements may be cached on the client device 202. If an advertisement is cached on the client device 202, the client library 210 may return a cached advertisement to the application 206 for presentation. Alternatively, a request is made for an advertisement to the ad platform 204 if an advertisement is not cached on the client device 202 or if it is desired to retrieve an advertisement from the ad platform 204 for some other reason. Further, requests for one or more advertisements may be made from the client device 202 to the ad platform 204 at any time and cached on the client device 202 for future use in an application, such as the application 206.

To request an advertisement from the ad platform 204, the client library 210 checks for the existence of an avatar ID on the client device 202. If an avatar ID is present, the request to the ad platform includes the avatar ID. If an avatar ID is not present, other information that may be employed by the ad platform 204 to identify an avatar ID may be included within the request. For instance, a user ID (e.g., an ID that is associated with personally identifiable information) and/or a machine unique ID may be provided to the ad platform 204, which may identify the avatar ID, for instance, by applying a hash function to the user ID and/or machine unique ID.

The ad platform 204 comprises an advertising system for the delivery of advertisements to client devices, such as the client device 202. As noted above, the ad platform 204 may comprise a single computing device, although it's likely that the ad platform 204 would be implemented via multiple computing devices in a distributed computing environment. As shown in FIG. 2, the ad platform 204 includes an ad selection component 212 that facilitates selection of advertisements for delivery to users. The ad selection component 212 includes a mobile adapter 214, an online adapter 216, and a TV adapter 218 that facilitate identifying the client device 202 as a particular type of device and adapting the advertisement experience for the client device 202 based on its type. The ad core delivery 220 handles requests for avatars from client devices such as the client device 202. The avatars comprise code that act as containers for avatar IDs and are provided to client devices and cached by an avatar widget on the client devices.

The ad selection component 212 includes an ad package selection component 222 that facilitates the selection of advertisements for delivery to client devices such as the client device 202. The ad package selection component 222 uses an avatar ID included in an advertisement request or determined based on information in the advertisement request to access data in a corresponding user profile 226 maintained by a targeting information service 224. The data from the user profile 226 includes information for the user, describing, for instance, the user's demographic information, personalities traits, likes, and/or dislikes. The information is used by the ad package selection component 222 to select an advertisement for delivery to the user device 202. In some embodiments, the ad package selection component 222 selects an advertisement also based on information external to the user profile. For instance, the ad package selection component 222 may select that advertisement based on both information from the user profile 226 and a context in which the advertisement will be presented on the user device. By way of example only and not limitation, in an embodiment in which the advertisement is presented on a search engine results page in conjunction with search results, the advertisement may be selected based in part on the search query terms used by the search engine and/or the search results provided on the search engine results page.

The advertisement selected by the ad package selection component 222 may comprise a package of multiple assets. Accordingly, based on the advertisement selection performed by the ad package selection component 222, the asset assembly component 228 performs dynamic asset retrieval and assembly for delivering an advertisement response to the client device 202. In some embodiments, a determination is made regarding whether an avatar image for the user's advertising avatar is to be included within the advertisement. For instance, the determination may be based on an indication that a user may interact with the advertisement such that when the advertisement is presented to the user, the avatar image serves as indicator to the user that the user may interact with the advertisement. In some embodiments, this may include an indication that user interaction with the advertisement will result in credits that the user may employ to obtain further features for the user's avatar image.

In some embodiments, a user's advertising avatar may include multiple avatar image states, each avatar image state comprising a different avatar image. By way of example only and not limitation, an advertising avatar may include a head state in which only the avatar image's head is provided, and a full state in which the entire avatar image is provided. Accordingly, in the event that an avatar image is to be included within an advertisement and multiple avatar image states are available, the avatar image state is determined.

After selecting and assembling an advertisement response, the ad platform 204 provides the advertisement response to the client device 202. The advertisement response includes the advertisement, which may include an asset-package. In some embodiments, the advertisement response includes an avatar image that is presented within the advertisement. In other embodiments, the advertisement response includes an indication that an avatar image is to be presented in the advertisement, and the client device 202 retrieves a cached avatar image for placement within the advertisement. The indication may include an indication of a particular avatar image state in the event that multiple avatar image states are available. In further embodiments, the advertisement response does not include an avatar image or an indication that an avatar image is to be displayed in the advertisement, and the advertisement is presented without an avatar image.

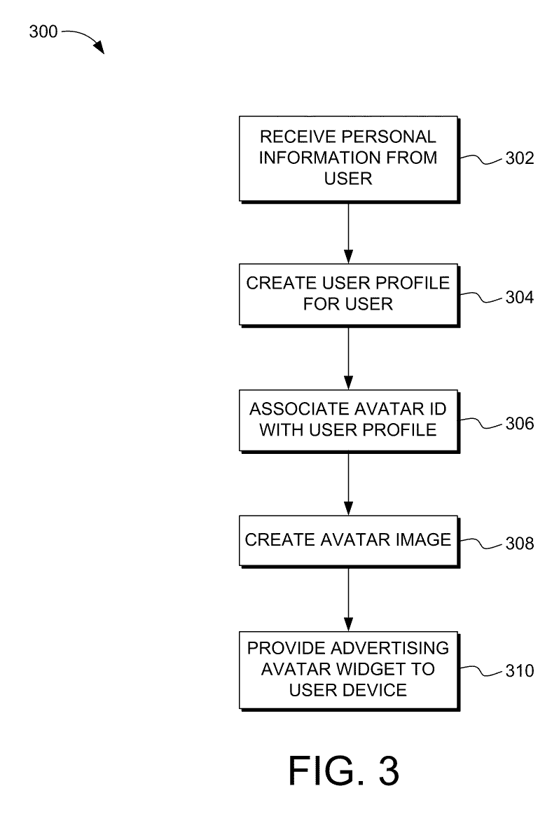

Turning now to FIG. 3, a flow diagram is provided that illustrates a method 300 for creating an advertising avatar for a user in accordance with an embodiment of the present invention. As shown at block 302, a user provides personal information to an advertising system provider that provides advertising avatars. As discussed previously, the user may provide a variety of different personal information. For instance, the user may provide demographic information, personality traits, likes, and/or dislikes, as well as other information. In accordance with embodiments of the present invention, the information provided by the user may be used in selecting aspects of the appearance of the user's advertising avatar image. For instance, the avatar image may include one or more accessories based on the user's personality traits. Additionally, the avatar image may perform particular actions based on the user's personal information.

A user profile is created for the user based on the information provided by the user, as shown at block 304. Additionally, an avatar ID is associated with the user profile at block 306. In some embodiments of the present invention, the avatar ID is an anonymous ID such that no personally identifiable information (e.g., name, address, etc.) is associated with the avatar. Instead, the avatar ID is associated with information that describes characteristics of the user, such as, for instance, the user's demographic information, personality traits, likes, and/or dislikes, but does not allow the user to be personally identified.

An avatar image is created and associated with the avatar ID, as shown at block 308. In some embodiments, the user may explicitly specify certain aspects of the appearance of the avatar image, such as for instance, the avatar image's skin color and hair color. In some embodiments, the avatar image may be based at least in part on an existing avatar for the user from another application or system (e.g., an avatar image from the XBOX gaming system). In some embodiments, at least a portion of the personal information from the user profile is used to determine at least a portion of the appearance of the avatar image. For instance, as noted above, the avatar image may include an accessory or may perform an action that is automatically selected by the system based on information from the user profile. In one embodiment, the personal information provided by the user is employed by the system to place the user in a named segment (e.g., “rolling stone,” “sports nut,” “gadget geek,” “fashionista,” “super parent,” “speed racer,” and “committed,” etc.) and the user's avatar image includes an accessory corresponding to the named segment. As such, the user's avatar image reflects the user's personality.

In some embodiments, an advertising avatar may have multiple avatar image states. For instance, an advertising avatar may include avatar image states that display varying amounts or portions of an avatar image. By way of example only and not limitation, in one embodiment, an advertising avatar may include a head state, which includes only a head portion of the avatar, and a full state, which includes the full avatar. Any number of avatar image states may be included for an advertising avatar in accordance with various embodiments of the present invention. By including different avatar image states, the system may provide an avatar image state that is appropriate for the context in which the avatar image is to be presented. For instance, if the avatar image is to be presented at a location with limited space, the head state may be selected.

As shown at block 310, an avatar widget is communicated to the user device for storage on the user device. The avatar widget comprises code for causing the user device to interact with a remote advertisement platform to facilitate delivery of advertisements to the user device for presentation to the user. Additionally, the avatar widget acts as a container for storing the avatar ID on the user device. As such, when an advertisement is requested for placement within an application on the user device, the avatar ID may be provided by the client device to facilitate advertisement selection and placement of the avatar image in some advertisements as will be described in further detail below.

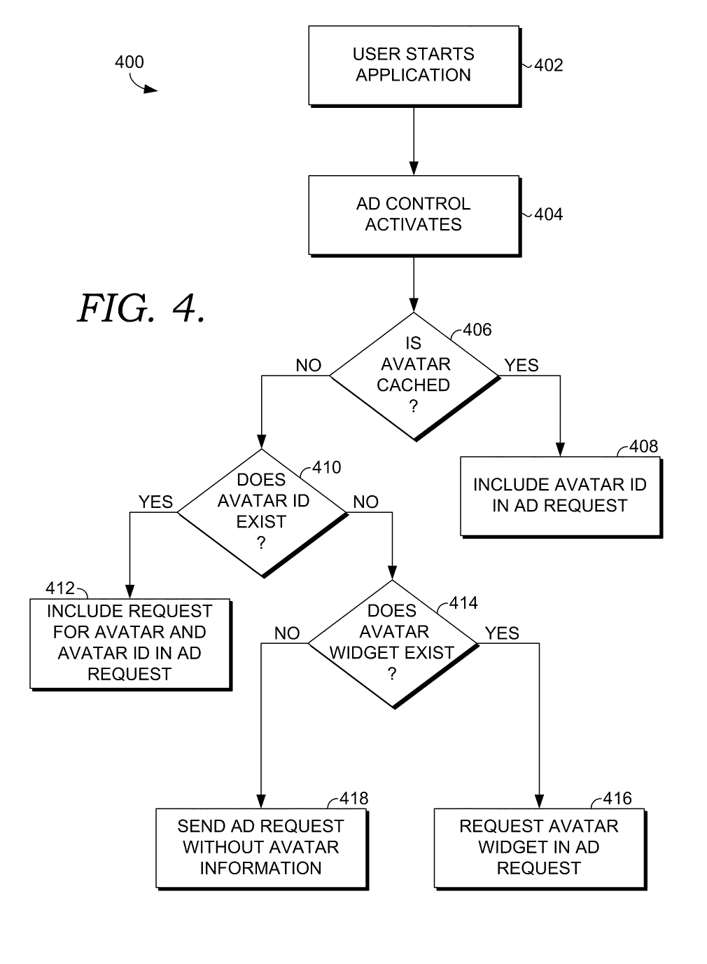

Referring next to FIG. 4, a flow diagram is provided that illustrates a method 400 performed by a client upon initiation of an ad control in accordance with an embodiment of the present invention. Initially, as shown at block 402, an application begins to run on the client device. While the application is running, an ad control activates based on the need for an advertisement for presentation within the application, as shown at block 404.

As shown at block 406, it is determined whether an avatar containing an avatar ID is cached on the client device. If the avatar containing the avatar ID is stored on the client device, an advertisement request that includes the avatar ID is generated and sent to an ad platform, as shown at block 408. If an avatar containing an avatar ID is not stored on the client device, it is next determined whether the user has an avatar ID at block 410. If the client can determine that an avatar ID exists, the advertisement request includes a request for the user's avatar containing the avatar ID at block 412. The advertisement request will include information, such as, for instance, a user ID or a machine unique ID, that allows for the identification of the appropriate avatar ID. If it is determined that the user does not have an avatar ID, it is determined at block 414 whether an avatar widget exists. If so, the avatar widget is requested as part of the advertisement request, as shown at block 416. Alternatively, an advertisement request is sent without any indication of and/or request for any avatar information, as shown at block 418.

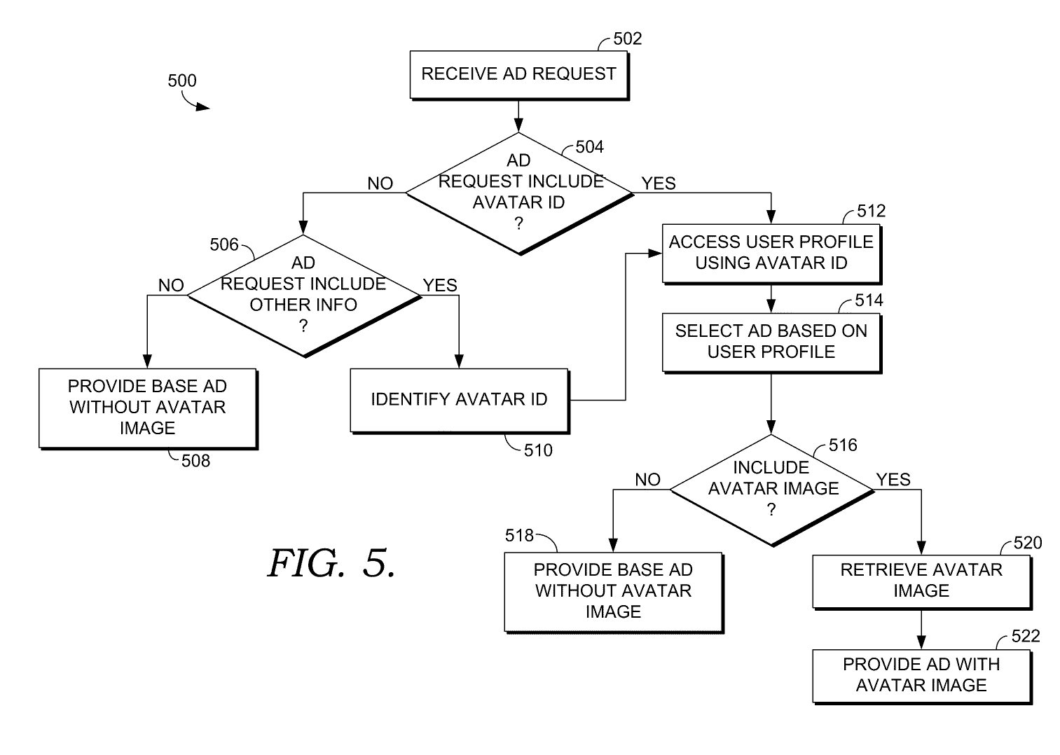

With reference now to FIG. 5, a flow diagram is provided that illustrates a method 500 performed by an ad platform for selecting an advertisement in response to an advertisement request from a client device in accordance with an embodiment of the present invention. Initially, as shown at block 502, an advertisement request is received from a client device. At block 504, it is determined whether the advertisement request includes an avatar ID. If the advertisement request does not include an avatar ID, it is determined whether the advertisement request includes other identifying information that may be used to identify an avatar ID (e.g., a user ID or machine unique ID), as shown at block 506. If the advertisement request does not include an avatar ID or other information that may be used to identify an avatar ID, a base advertisement is selected and provided to the client device without employing information in a user profile associated with an avatar ID and without an avatar image, as shown at block 508. Alternatively, if the request includes information that allows for the identification of an avatar ID, the avatar ID is identified at block 510.

As shown at block 512, the avatar ID included with the advertisement request or determined based on other information included in the advertisement request is used to access a user profile associated with the avatar ID. An advertisement is selected based on the user profile, as shown at block 514. It is determined at block 516 whether an avatar image is to be included as part of the displayed advertisement. The determination of whether an avatar image is to be included as part of the advertisement may be based on a number of factors in various embodiments of the present invention. For instance, in some embodiments, an avatar image is included as part of the advertisement as an indication that a user may interact with the advertisement. In some embodiments, an avatar image is included as part of the advertisement as an indication that the user may receive credits for interacting with the advertisement. Avatar images may be included within advertisements for other purposes within the scope of embodiments of the presented invention.

If it is determined that in an avatar image is not to be displayed within the advertisement, the advertisement is provided to the user device without an avatar image and without an indication that an avatar image will be presented as part of the advertisement, as shown at block 518. Alternatively, if it is determined that an avatar image will be presented as part of the advertisement, an avatar image is retrieved at block 520. The advertisement including the avatar image is provided to the client device at block 522.

In some embodiments, instead of retrieving the avatar image and providing the avatar image to the client device with the advertisement, the ad platform may provide the advertisement to the client device without the avatar image but with an indication that an avatar image is to be displayed as part of the advertisement. The client device may then retrieve the avatar image, which may be cached on the client device, and present the advertisement including the avatar image.

In embodiments in which an advertising avatar includes multiple avatar image states, the method may further include determining which avatar image state to employ for a given advertisement. The avatar image state may be selected based on a variety of factors, such as, for instance, the context in which the advertisement will be presented and/or aspects of the advertisement in which the avatar image will appear. The appropriate avatar image corresponding with the selected avatar image state may then be provided to the client device with the advertisement or the advertisement provided to the client device may include an indication of the avatar image state such that the client device may retrieve a cached avatar image corresponding with the avatar image state for presentation within the advertisement.

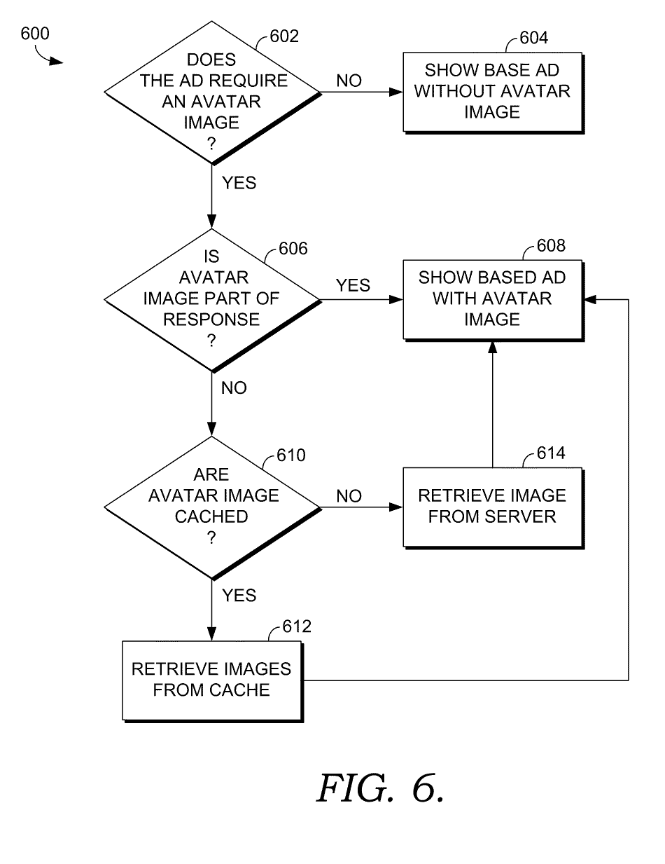

Referring to FIG. 6, a flow diagram is provided that illustrates a method 600 for presenting an advertisement in an application on a client device in accordance with an embodiment of the present invention. As shown at block 602, it is determined whether the advertisement requires an avatar image. For instance, as discussed above with reference to FIG. 5, the advertisement response from the ad platform may include an avatar image or may include an indication that an avatar image is to be presented as part of the advertisement. If it is determined that an avatar image is not required, the base advertisement is presented without an avatar image, as shown at block 604. Alternatively, if an advertisement requires an avatar image, it is determined whether the avatar image is provided as part of the advertisement response from the ad platform to the client device, as shown at block 606. If the ad platform did return an avatar image as part of the advertisement response, the advertisement is presented with the avatar image, as shown at block 608.

If the avatar image is not provided as part of the advertisement response, it is determined at block 610 whether the avatar image is cached on the client device. In some embodiments, this may include identifying a particular avatar image state for the present advertisement. If it is determined that the avatar image is cached on the client device, the avatar image is retrieved from the cache on the client device, as shown at block 612. The advertisement is then presented with the avatar image at block 608. If it is determined at block 610 that the avatar image is not cached on the client device, the avatar image is retrieved from the server, as shown at block 614. The advertisement is then presented with the avatar image at block 608.

An avatar image associated with a user's advertising avatar may be displayed in a variety of different settings. For illustrative purposes only, FIGS. 7-9 include exemplary screen displays showing advertising avatar images in accordance with various embodiments of the present invention. It will be understood and appreciated by those of ordinary skill in the art that the screen displays of FIGS. 7-9 are provided by way of example only and are not intended to limit the scope of the present invention in any way.

With reference initially to FIG. 7, an illustrative screen display 700 for a mobile device is shown. As shown in FIG. 7, the user interface shown in the screen display 700 includes an advertising avatar widget icon 702. Although the advertising avatar widget icon 702 is shown on a mobile device in FIG. 7, it should be understood that the advertising avatar widget icon 702 may be displayed on any type of computing device. The advertising avatar widget icon 702 allows the user to access information associated with the user's advertising avatar. For instance, the user may access and/or edit information in the user's profile.

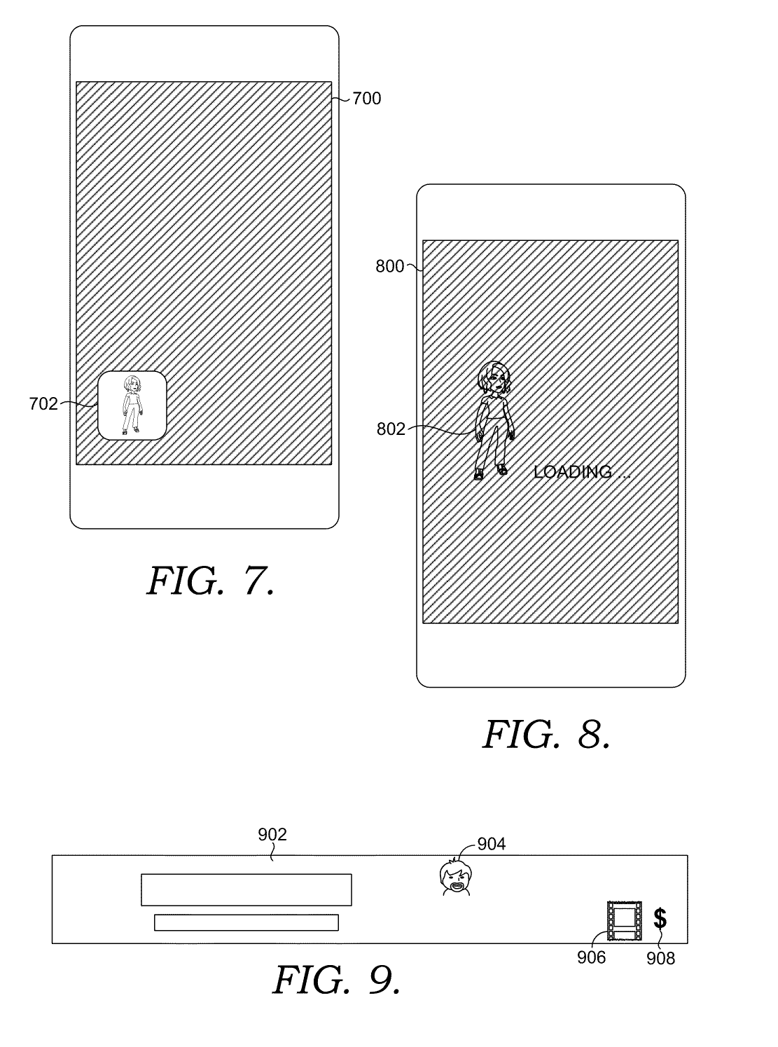

As shown in FIG. 8, another location in which an avatar image 802 associated with a user's advertising avatar may be displayed is a progress bar. FIG. 8 illustrates an illustrative screen display 800 for a mobile device. Although the avatar image 802 is shown on a mobile device in FIG. 8, it should be understood that the avatar image 802 may be displayed on any type of computing device. In some embodiments, the avatar image 802 is a static image, while in other embodiments, the avatar image 802 is animated. For instance, the user may have obtained an action for his/her avatar. In such instances, the avatar image 802 is animated based on the action.

FIG. 9 illustrates the placement of an avatar image 904 within an advertisement 902. For the sake of simplicity, the content of the advertisement 902 is not shown within FIG. 9. As discussed previously, an advertising avatar may have different display states with corresponding images. In the example of FIG. 9, a headshot is provided as the avatar image. In other embodiments, the avatar image placed within an advertisement may be a full avatar image. Additionally, is some embodiments, if the user has obtained an action for the advertising avatar, the avatar image may perform the action within the advertisement. In further embodiments, the advertising image may interact with the content of the advertisement. Any and all variations are contemplated to be within the scope of embodiments of the present invention.

The advertisement 902 shown in FIG. 9 includes additional icons allowing a user to select particular functions. Icon 906 allows a user to select to watch a video associated with the advertisement. Icon 908 provides an option for the user to purchase the product or service associated with the advertisement.

As can be understood, embodiments of the present invention provide an advertising avatar that provides an engaging and entertaining advertising experience for users. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media storing computer-useable instructions that, when used by one or more computing devices, causes the one or more computing devices to perform a method comprising:
receiving personal information from a user, the personal information describing at least one of the following: demographic information for the user, a personality trait of the user, a like of the user, and a dislike of the user;
storing the personal information in a user profile;
associating the user profile with an avatar ID;
employing at least a portion of the personal information from the user profile to determine at least a portion of an appearance of an avatar image for the user; and
employing at least a portion of the personal information from the user profile to select online advertisements for electronic delivery to the user.

2. The one or more computer-readable media of claim 1, wherein at least a portion of the personal information received from the user is specified by the user using a taxonomy provided by an advertising system provider, and wherein the taxonomy is also used by advertisers to describe the advertisers' target audience.

3. The one or more computer-readable media of claim 2, wherein the taxonomy is also used by application developers to describe a context of applications in which advertisements are placed and site publishers to describe a context of sites in which advertisements are placed.

4. The one or more computer-readable media of claim 2, wherein the method further comprises:
receiving, from the user, a new element for the taxonomy;
adding the new element to the taxonomy; and
providing the new element as part of the taxonomy provided to other users and advertisers.

5. The one or more computer-readable media of claim 1, wherein the avatar ID is an anonymous identifier.

6. The one or more computer-readable media of claim 1, wherein employing at least a portion of the personal information from the user profile to determine at least a portion of the appearance of the avatar image for the user comprises:
determining a named segment based on a personality trait of the user; and
providing an image of an accessory as part of the avatar image based on the named segment.

7. The one or more computer-readable media of claim 1, wherein employing at least a portion of the personal information from the user profile to determine at least a portion of the appearance of the avatar image for the user comprises:
determining a named segment based on a personality trait of the user; and
providing an action for the avatar image based on the named segment.

8. The one or more computer-readable media of claim 1, wherein the method further comprises providing credit to the user for interacting with an advertisement, wherein the credit is useable by the user to obtain further accessories and actions for the avatar image.

9. The one or more computer-readable media of claim 1, wherein the method further comprises tracking behavioral information for the user and adding the behavioral information to the user profile.

10. The one or more computer-readable media of claim 9, wherein at least a portion of the appearance of the avatar image is automatically determined based on the behavioral information.

11. A method performed by one or more server devices for selecting and providing an advertisement to a client device, the method comprising:
receiving, from the client device, a request for an advertisement for presentation within an application on the client device;
identifying an avatar ID based on the request for the advertisement;
accessing a user profile associated with the avatar ID, the user profile comprising personal information for a user associated with the avatar ID;
selecting an advertisement based at least in part on at least a portion of the personal information from the user profile;
determining that an avatar image is to be presented within the advertisement;
providing the advertisement to the client device; and
providing to the client device, an avatar image or an indication that an avatar image is to be presented within the advertisement, wherein the avatar image is presented within the advertisement on the client device.

12. The method of claim 11, wherein the request for the advertisement includes the avatar ID and wherein identifying the avatar ID based on the request for the advertisement comprises identifying the avatar ID in the request.

13. The method of claim 11, wherein the request for the advertisement includes other information that facilitates identification of the avatar ID.

14. The method of claim 11, wherein determining that the avatar image is to be presented within the advertisement is based on a determination that the advertisement allows the user to directly interact with the advertisement.

15. The method of claim 11, wherein providing, to the client device, the avatar image or the indication that the avatar image is to be presented within the advertisement comprises:
identifying the avatar image based on the avatar ID;
placing the avatar image within the advertisement; and
communicating the advertisement containing the avatar image to the user device for presentation to the user.

16. The method of claim 11, wherein providing, to the client device, the avatar image or the indication that an avatar image is to be presented within the advertisement comprises providing, to the user device, the indication that an avatar image is to be presented within the advertisement, wherein the user device accesses the avatar image based on the indication and presents the avatar image within the advertisement.

17. The method of claim 11, wherein the method further comprises selecting the avatar image to be presented within the advertisement, the avatar image being selected from a plurality of avatar image states associated with the avatar ID, each avatar image state being associated with a different avatar image.

18. The method of claim 11, wherein the advertisement is selected based at least in part on information external to the user profile.

19. The method of claim 11, wherein the advertisement is selected based at least in part on a context in which the advertisement will be presented on the user device.

20. One or more computer-readable media storing computer-useable instructions that, when used by one or more computing devices, causes the one or more computing devices to perform a method comprising:
receiving personal information from a user, the personal information describing at least one of the following: demographic information for the user, a personality trait of the user, a like of the user, and a dislike of the user;
creating an advertising avatar for the user based on at least a portion of the personal information from the user, wherein the advertising avatar is associated with an avatar ID comprising an anonymous identifier, wherein the advertising avatar is associated with an avatar image, wherein at least a portion of the avatar image is explicitly specified by the user, and wherein the avatar image includes an accessory automatically determined based on at least a portion of the personal information from the user without the user explicitly specifying the accessory;
communicating an avatar widget to a user device for storage on the user device, wherein the avatar widget comprises code for causing the user device to interact with a remote advertisement platform to facilitate delivery of advertisements to the user device for presentation to the user, and wherein the avatar widget acts as a container for storing the avatar ID on the user device;
receiving from the user device, a request for an advertisement, wherein the request includes the avatar ID;
selecting an advertisement based at least in part on at least a portion of the personal information received from the user;
determining that the advertisement is configured to allow user interaction with the advertisement;
based on the determination that the advertisement is configured to allow user interaction with the advertisement, retrieving the avatar image; and
providing the advertisement and the avatar image to the user device, wherein the avatar image is presented within the advertisement on the user device to indicate to the user that the advertisement allows user interaction.
